(19) United States
(12) Patent Application Publication
(10) Pub. No.: US 2004/0206446 A1
(43) Pub. Date: Oct. 21, 2004

(54) Flexographic method for labels

(76) Inventor: Richard A. Charley, Woodbury, MN (US)

Correspondence Address: BRIGGS AND MORGAN, P.A., 2200 IDS CENTER, MINNEAPOLIS, MN, 55402, US

(21) Appl. No.: 10/418,692

(22) Filed: Apr. 18, 2003

(51) Int. Cl. B32B 31/18

(52) U.S. Cl. 156/247; 156/267; 156/277; 156/272.2; 156/510

(57) ABSTRACT

Methods and apparatus for producing labels on continuous stock, by removing waste areas from the areas of the stock upon which the labels are printed. In one method, a layer of adhesive is applied over the unprinted label areas, the label areas are die cut, and a waste carrier is applied to the adhesive to remove the waste areas. In a second method, the stock is separated from its backing, exposing the adhesive, and a spot adhesive deadener is applied in a pattern corresponding to the waste areas. The backing layer is then reapplied to the stock, the labels are printed and die cut, and the waste area, no longer bound by the adhesive, is stripped off. The methods are implemented by a flexographing printing and converting machine.

### BACKGROUND OF THE INVENTION

The present invention relates to a method and apparatus for producing labels on continuous stock.

Various methods of printing labels on continuous stock and separating the printed labels from the stock are known. However, these methods generally involve die cutting of the labels, followed by some manually-intensive way of separating the printed labels from the stock.

There is a need for an improved method and apparatus that addresses the above problem by automatically removing the unprinted waste areas from the continuous stock, leaving the printed labels behind.

### SUMMARY OF THE INVENTION

Methods and apparatus for producing labels on continuous stock, by removing waste areas from the areas of the stock upon which the labels are printed. In one method, a layer of adhesive is applied over the unprinted label areas, the label areas are die cut, and a waste carrier is applied to the adhesive to remove the waste areas. In a second method, the stock is separated from its backing, exposing the adhesive, and a spot adhesive deadener is applied in a pattern corresponding to the waste areas. The backing layer is then reapplied to the stock, the labels are printed and die cut, and the waste area, no longer bound by the adhesive, is stripped off. The methods are implemented by a flexographing printing machine.

A principal object and advantage of the present invention is that it expedites the removal of waste areas from the stock.

### BRIEF DESCRIPTION OF DRAWINGS

FIG. 1 is a top plan view of continuous blank stock with labels printed thereon.

FIG. 2 is similar to FIG. 1, with the addition of areas of adhesive applied in the cross-hatched areas.

FIG. 3 is similar to FIG. 1, with the addition of die-cuts and cross-hatching showing areas of continuous stock to be removed to produce the final labels.

FIG. 4 is a top plan view of a label produced according to the present invention.

FIG. 5 is a series of cross-sections of the blank stock of the present invention at various steps of the invention.

FIG. 6 shows one embodiment of a flexographic apparatus implementing the present invention.

FIG. 7 shows a second embodiment of a flexographic apparatus implementing the present invention.

### DETAILED DESCRIPTION OF THE PREFERRED EMBODIMENT

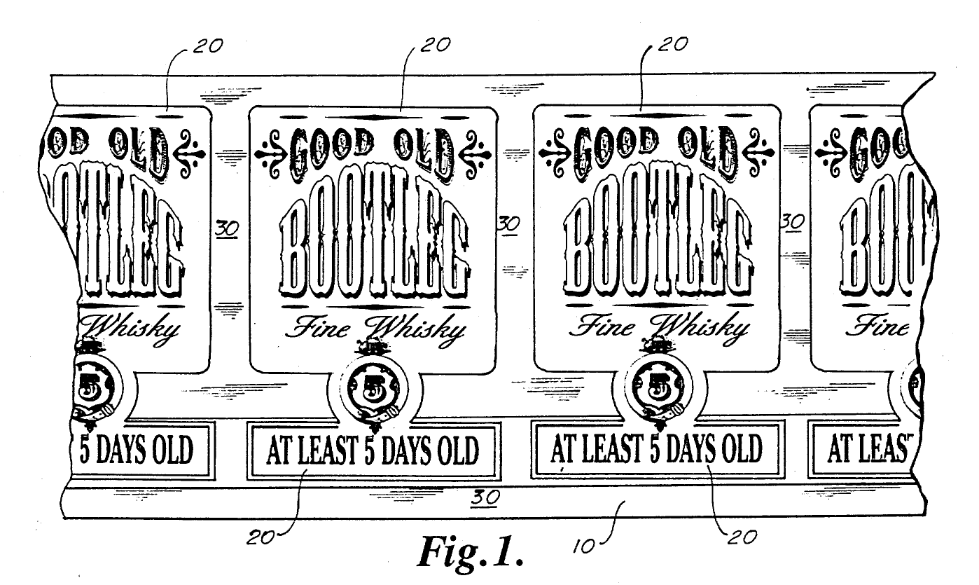

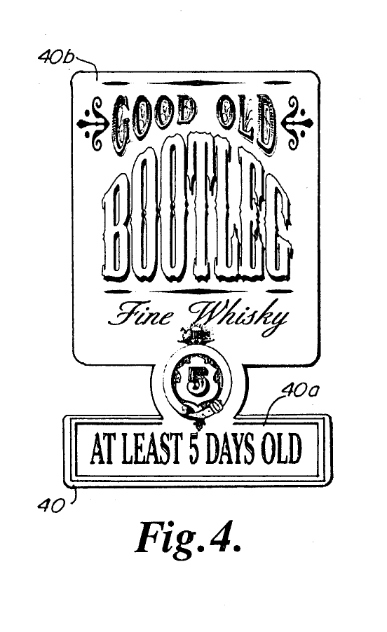

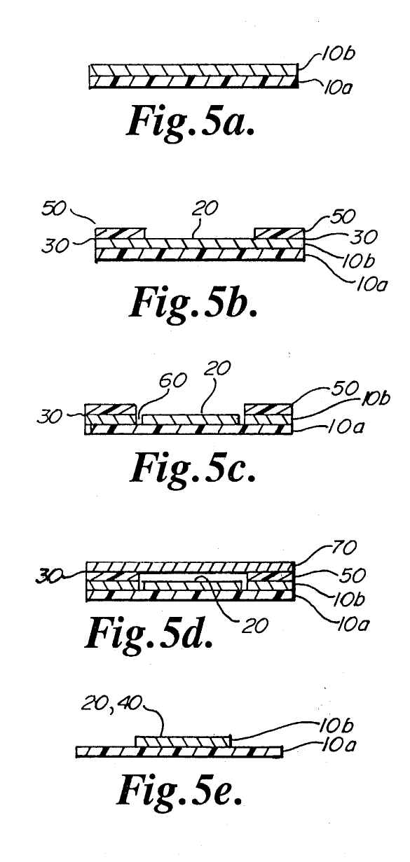

FIG. 1 shows a length of continuous blank stock 10 upon which have been printed a series of label areas 20. Between the label areas 20 are areas 30 of stock that must be removed to create the final labels. Stock 10 may have a film backing 10a which is separable from a printable layer 10b upon which the label areas are printed, as shown n FIG. 5a. FIG. 4 shows a label 40 produced by the present invention, after the areas 30 have been removed by the method of the invention. Illustratively, label 40 may comprise separate parts 40a, 40b connected together.

The areas 30 have, in the past, been removed by die cutting. However, after the die cuts were made, previous methods left the removal of the areas 30 by manually-intensive methods.

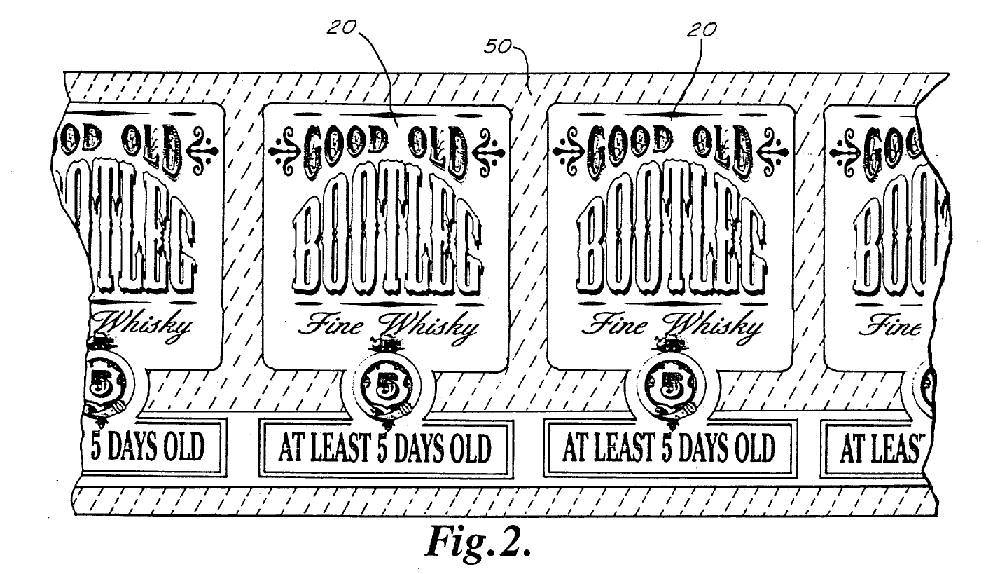

In a first embodiment of the method of the present invention, the areas 30 of stock to be removed are first overlaid with a layer of adhesive 50, as shown in FIGS. 2 and 5b. The adhesive 50 may be applied by a screen, flexographic plate, or other method in such a way as to cover only the areas 30 and not the label areas 20. The adhesive is then cured.

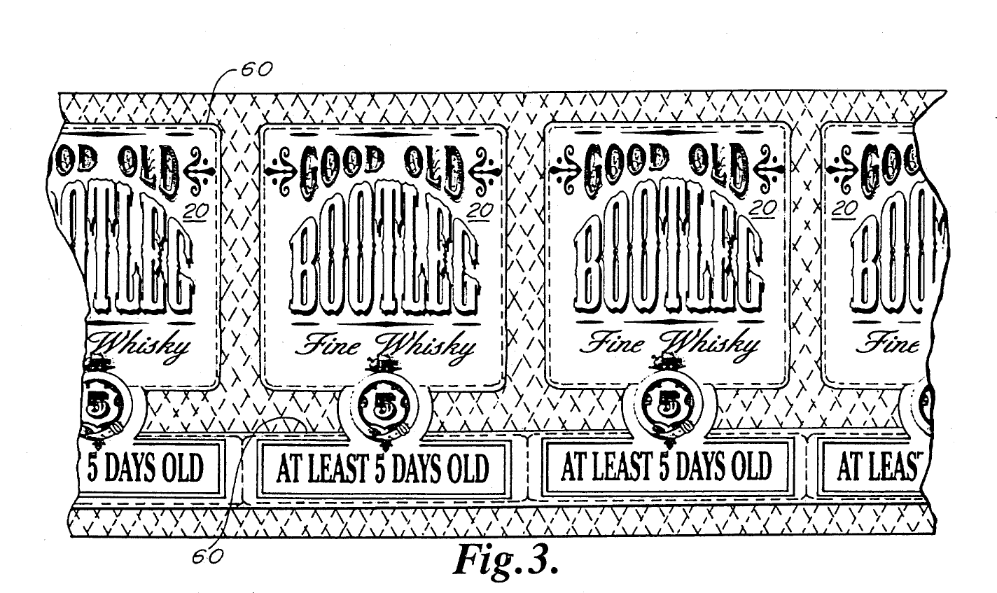

In the next step, shown in FIGS. 3 and 5c, the stock is die cut along cut lines 60, delineating the areas 30 of stock to be removed.

Next, as shown in FIG. 5d, a continuous waste carrier 70 is applied over the cured adhesive 50 and the label areas 20, bonding to the cured adhesive but not to the label areas 20.

In the last step, the waste carrier is stripped away from the stock 10, carrying with it the stock from the areas 30 and leaving behind the final labels 40 on the printable layer 10b, as shown in FIG. 5e. The continuous stock 10 is then wound onto a receiving roller.

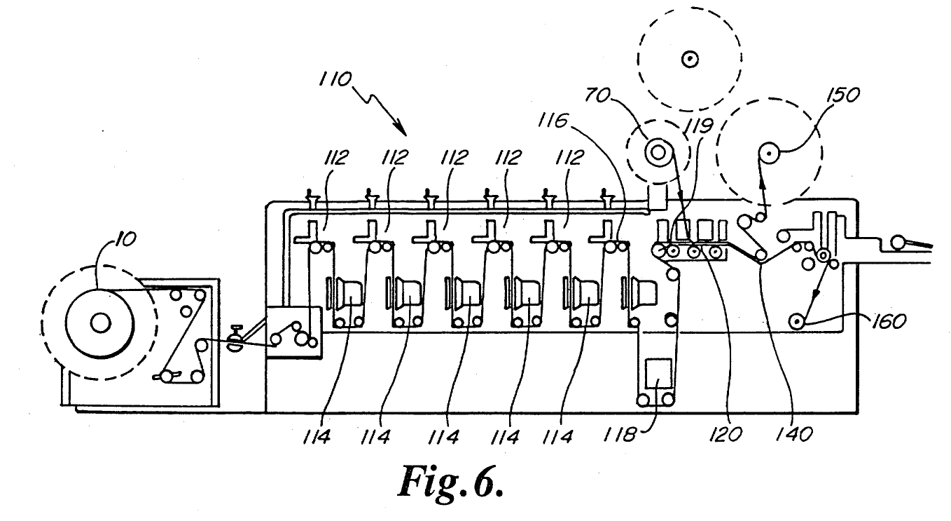

A flexographic printing apparatus for carrying out the method of the present invention is shown in FIG. 6 by reference numeral 110. Apparatus 110 is, for example, a flexographic printing press machine, the WEBTRON™ 750, or the like, available from Paper Converting Machine Company, Green Bay, Wis. 54307-9043.

The continuous stock 10 is fed into the machine 110 and through a number of flexographic press stations 112. Each flexographic station 112 may imprint a particular color of ink or coating onto the stock 10, creating the label areas 20. After each station 112, the continuous stock 110 is run through a dryer 114 before being routed to the next station 112.

When the stock reaches flexographic station 116, adhesive 50 is continuously applied to the stock only over the areas 30 of stock to be removed. The adhesive may be applied to these areas by a screen or flexographic plate. The stock is then run past a unit 118 to cure the adhesive.

At station 119, a rotary die cutter cuts the stock to separate the label areas 20 from the areas 30 of stock to be removed.

At flexographic station 120, the waste carrier 70 is married to the stock 10, binding to the cured adhesive.

At station 140, the stock with married waste carrier is bent in such a way as to lift the leading edge of the waste carrier away from the stock 10. The waste carrier 70 is then wound onto waste receiving roller 150.

The continuous stock 10 with final labels 40 is then wound onto stock receiving roller 160.

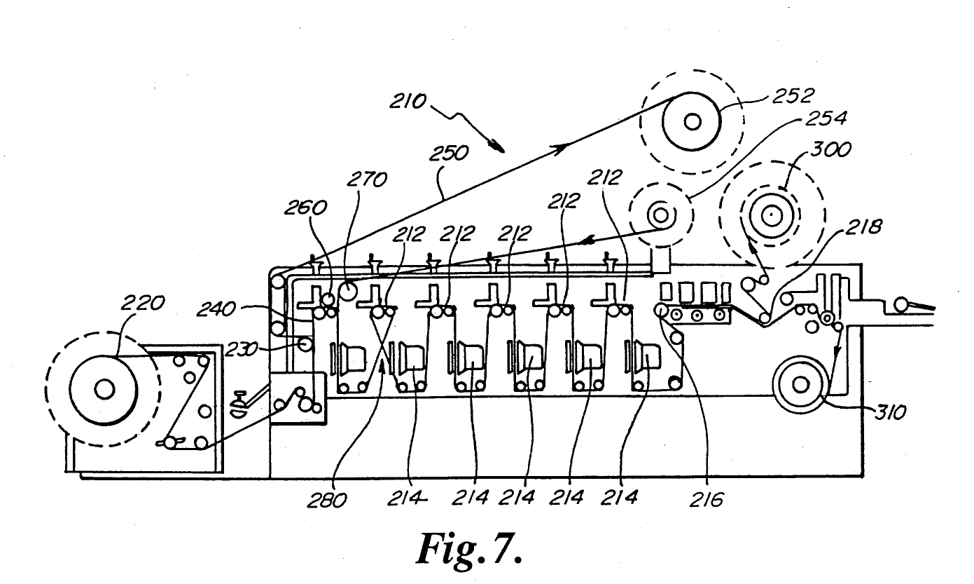

A second embodiment of the method and apparatus of the present invention is illustrated in FIG. 7.

Continuous stock to be used in the second embodiment is fed into the flexographic machine 210 at input 220. The continuous stock consists of a printable layer attached to a backing layer (typically clear, 1 mil polypropylene) by an adhesive.

At station 230, the printable layer 240 is separated from the backing layer 250, with the backing layer being wound onto a receiving roller 252 for recycling. The printable layer 240 with adhesive next enters station 260, where spot adhesive deadener is applied to the adhesive in the areas 30 of stock to be removed.

At station 270, the backing layer is reapplied to the spot-deadened adhesive layer from a roller 254.

The continuous stock next enters web turner 280, where the stock is turned so that the side to be printed on is exposed. The stock is then printed in the label areas 20 at successive press stations 212, followed by a run through each successive dryer 214 to dry the ink.

When the stock reaches station 216, it is die cut to separate the label areas 20 from the areas 30 of stock to be removed.

At station 218, the areas 30 of stock to be removed are easily stripped off the continuous stock, because the adhesive beneath these areas was previously deadened. The stock 30 to be removed is wound onto waste receiving roller 300, while the printed labels 40 remaining on the backing are wound onto receiving roller 310.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention.

What is claimed:

1. A method for producing labels on continuous stock, comprising the steps of:
(a) printing the labels on label areas on the continuous stock, leaving unprinted waste areas on the continuous stock;
(b) applying a layer of adhesive only to the unprinted waste areas;
(c) making cuts between the label areas and the waste areas;
(d) applying a waste carrier to the adhesive; and
(e) separating the waste carrier, the adhesive, and the unprinted waste areas from the continuous stock.

2. The method of claim 1, further comprising a step of curing the adhesive between steps (b) and (c).

3. The method of claim 2, wherein the adhesive is cured by exposure to ultraviolet light.

4. The method of claim 1, wherein step (c) comprises die cutting.

5. The method of claim 1, wherein the adhesive is applied by means of a flexographic plate.

6. The method of claim 1, wherein the adhesive is applied by means of a screen.

7. Apparatus for carrying out the method of claim 1, comprising:
(a) a flexographic printing press machine having a number of press stations;
(b) a dryer associated with each press station;
(c) an adhesive-applying press station having a flexographic plate corresponding to the unprinted waste areas;
(d) an ultraviolet source for curing the adhesive;
(e) a die cutter station;
(f) a waste carrier-applying press station;
(g) a mechanism for separating the waste carrier from the continuous stock;
(h) a waste carrier receiving roller; and
(i) a continuous stock receiving roller.

8. A method for producing labels on continuous stock, the stock having a backing layer, a printable layer, and an adhesive therebetween, comprising the steps of:
(a) separating the backing layer from the adhesive;
(b) applying a spot adhesive deadener in a pattern delineating waste areas of stock to be removed;
(c) re-applying the backing layer to the adhesive;
(d) turning the stock to expose the printable layer;
(e) printing label areas on the printable layer;
(f) making cuts between the label areas and the waste areas; and
(g) separating the waste areas from the stock.

9. The method of claim 8, wherein step (f) comprises die cutting.

10. The method of claim 8, wherein the spot adhesive deadener is applied by means of a flexographic plate.

11. The method of claim 8, wherein the spot adhesive deadener is applied by means of a screen.

12. Apparatus for carrying out the method of claim 8, comprising:
(a) a flexographic printing press machine having a number of press stations;
(b) a dryer associated with each press station;
(c) a spot adhesive deadener applying press station having a flexographic plate corresponding to the unprinted waste areas;
(d) a die cutter station;
(e) a mechanism for separating the waste carrier from the continuous stock;
(f) a waste receiving roller; and
(g) a continuous stock receiving roller.
